(19) United States
(12) Patent Application Publication
(10) Pub. No.: US 2003/0227918 A1
(43) Pub. Date: Dec. 11, 2003

(54) Method for identifying at least one port assigned to a centrex group in a telecommunication system

(76) Inventor: Damjan Cibej, Kamnik (SI)

Correspondence Address: Kevin R. Spivak, Morrison & Foerster LLP, Suite 300, 1650 Tysons Boulevard, McLean, VA, 22102, US

(21) Appl. No.: 10/366,698

(22) Filed: Feb. 14, 2003

(30) Foreign Application Priority Data
Feb. 15, 2002 (DE) 102 06 401.6

(51) Int. Cl. H04L 12/28

(52) U.S. Cl. 370/392; 370/475

(57) ABSTRACT

A method for identifying at least one port (A, B) assigned to a Centrex group in a telecommunication system (SYS) with a plurality of Centrex switching centers (VSA, VSB) connected to each other via a telecommunication network (NET), to each of which at least one Centrex group port (A, B) is assigned, with a virtual and physical call number (PRA) of the calling port (A) being transferred, when a call is set up from a port (A) of a first switching center (VSA) to a port (B) of a second switching center.

The invention relates to a method for identifying at least one port assigned to a Centrex group in a telecommunication system with at least two Centrex switching centers connected to each other via a telecommunication network, to each of which at least one of the Centrex group ports is assigned, with both a physical call number in the telecommunication network and a Centrex group-internal, virtual call number assigned to each of the ports and when a call is set up between a calling port assigned to a first Centrex switching center and a port assigned to a second Centrex switching center at least the Centrex group-internal, virtual call number of the calling port being signaled by the first Centrex switching center to the telecommunication network and being transferred by this to the second Centrex switching center.

The invention also relates to a telecommunication system with at least two Centrex switching centers connected to each other via a telecommunication network, to each of which at least one Centrex group port is assigned, with both a physical call number and a Centrex group-internal, virtual call number assigned to each of the ports and each Centrex switching center being set up to signal at least the Centrex group-internal, virtual call number of the calling port to the telecommunication network when a call is set up between a calling port assigned to it and a second port assigned to a different Centrex switching center, with the telecommunication network set up to transfer call numbers signaled by the calling Centrex switching center to the called Centrex switching center.

With Centrex groups (Central Office Exchange Service; see also: Bocker, Peter: Digitale Netze für Sprach-, Text-, Daten Video-Multimediakommunikation [Digital networks for voice, text, data, video multimedia communication], Springer; 1997) it is possible to integrate existing standard individual ports in a public telecommunication network in a PBX or telecommunication system via a Centrex switching center. In the Centrex group context, public telecommunication network ports assigned to a Centrex switching center have both a virtual, Centrex group-internal call number and an actual physical telephone number in the (public) telephone network.

If a subscriber within a Centrex group dials an extension number assigned to a Centrex group port, a line can be established to this terminal and the virtual, Centrex group-internal extension number of the calling subscriber or terminal can be shown on a display at the terminal dialed. The called subscriber can identify from the displayed virtual number that the calling subscriber is a Centrex group subscriber. The applicant's DE 19946445 A1 is also known in relation to Centrex groups.

The Malicious Call Identification or MCI service can be activated by a Centrex group user. This service allows identification of a calling port assigned to the Centrex switching center to which the port activating the MCI is also assigned. Also external individual public telecommunication network ports can be identified by means of MCI. It is irrelevant here whether ISDN or analog lines are involved. There are two variations of this service. With automatic MCI the date, time, duration and call number of every incoming call are automatically recorded. In the case of manual call identification, the user has to input a short number code (usually *39#). This must generally be input either during the call or within 30 seconds after the end of the call.

MCI is a standardized ETSI feature (ETS 300 128) in Euro-ISDN, which can identify and record the source of calls from the public telecommunication network, even if the caller wishes to remain anonymous. This feature can be used, as mentioned above, to determine the line data of incoming calls. As the call number of the calling port forwarded to the called port is generally verified by the public telecommunication network, this ensures that the actual call number of the caller is transferred to the called party. However this only applies to the part of the call number for which the public telecommunication network is responsible.

It may be the case with larger Centrex groups that the group is distributed over a (public) telecommunication network. Generally a distributed Centrex group has a plurality of Centrex switching centers connected to each other via the (public) telecommunication network, which are usually operated by different providers.

In the event of a call from a first port assigned to a first Centrex switching center of the Centrex group to a second port assigned to a second Centrex switching center of the Centrex group, the individual Centrex switching centers and the ports assigned to them are seen by the public telecommunication network as a PBX or telecommunication system, with the public call number being forwarded, as known, in the form trunk access code+local area code+public (physical) call number of the Centrex switching center+virtual, Centrex group-internal extension number, to the second Centrex switching center. This ensures that the extension number of the calling subscriber can be shown at the terminal of a called subscriber in the Centrex group, which is assigned to a different Centrex switching center from the calling subscriber.

In the context of MCI however the virtual, Centrex group-internal, virtual call numbers are not verified for correctness by the (public) telecommunication network, as the competence of the public network ends at a Centrex switching center, as with any other PBX. As extension numbers may be allocated on a proprietary basis in a Centrex group or a PBX unit, unambiguous identification of an extension port is not possible from the call number or calling party number forwarded by the calling Centrex switching center to the called Centrex switching center, as this, as mentioned above, is not identical to the physical call number of the calling extension. The same problem arises with officially instituted monitoring, known as Lawful Interception, or LI, of the calling or called port.

It is therefore the object of the invention to eliminate the above disadvantages.

This object is achieved according to the invention with a method of the type mentioned above in that when a call is set up the actual, physical call number of the calling port is also signaled by the Centrex switching center to the telecommunication network, along with the Centrex group-internal, virtual call number.

For the sake of simplicity, a Centrex switching center and the ports assigned to it are referred to below as a PBX.

When a call is set up from a port of a first PBX to a port of a different PBX, according to the invention the actual, physical call number of the calling port in the (public) telecommunication network (calling party number), and an additional number (additional calling party number) are transferred to the PBX of the called distant end. The transferred physical number of the calling port can then be used for MCI or LI.

A further number (additional private group party) can also be transferred to the Centrex switching center of the called distant end along with the physical call number of the calling Centrex switching center and the virtual call number of the calling extension. In this way it can be ensured that all information which is required for known Centrex services, such as, for example, Centrex group dialing calls, is available.

Advantageously therefore, when a call is set up between the calling port and the called port of the first Centrex switching center, an addressing message is signaled to the telecommunication network, the first part of which contains the physical call number of the first port and a further part of which contains the virtual call number of the first port and the physical call number of the first Centrex switching center.

If the addressing message has a third part, which contains the virtual call number of the calling port, it can be verified by a known means, whether a call should be set up via a (lower cost) group-internal Centrex line or a (more expensive) public Centrex line.

A telecommunication system of the type mentioned above is particularly suitable for implementing the method according to the invention, in which the Centrex switching center to which the calling port is assigned is set up to signal the actual, physical call number of the calling port to the telecommunication network along with the Centrex group-internal, virtual call number, when the call is set up from the first port to the second port.

Further advantageous claims for the telecommunication system can be found in dependent claims 5 and 6.

The invention and further advantages are described in more detail below using a non-restrictive embodiment, which is shown in the drawing. This shows:

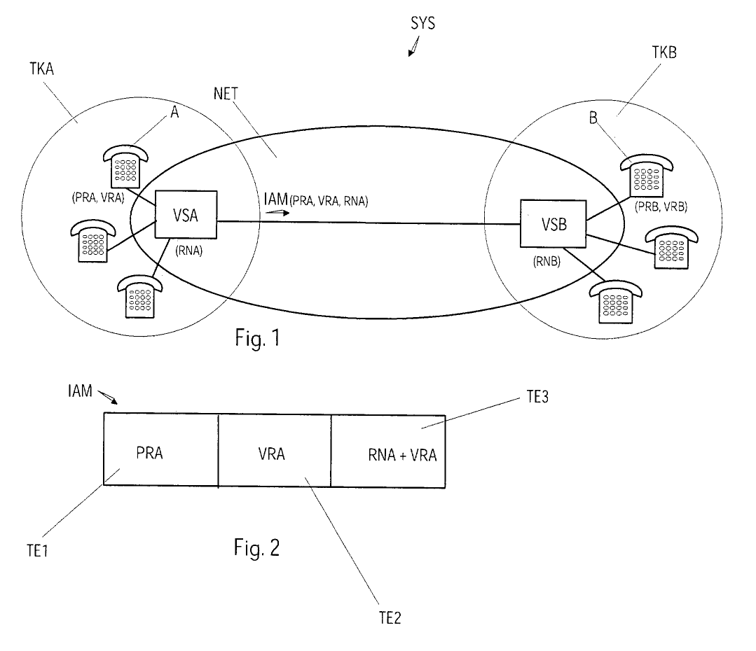

FIG. 1 a telecommunication system according to the invention,

FIG. 2 a message signaled by a Centrex switching center assigned to a calling port in the context of setting up a call,

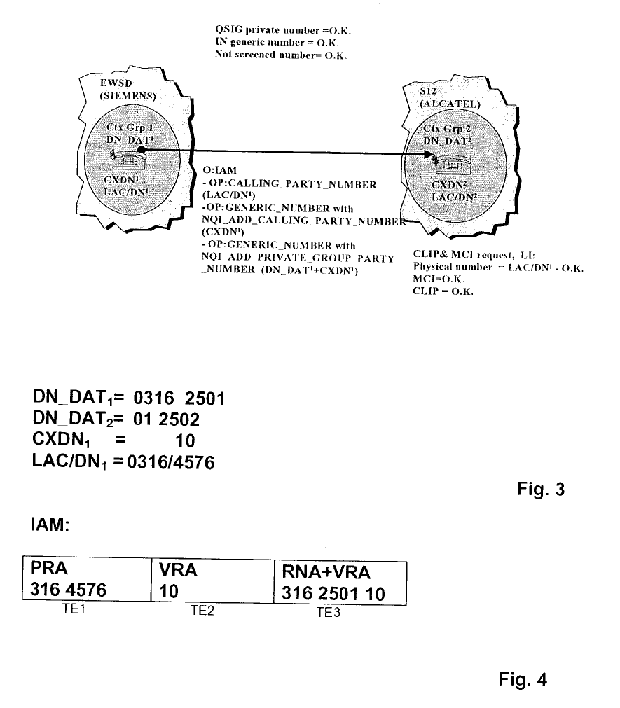

FIG. 3 a different illustration of the telecommunication system according to the invention from FIG. 1 and

FIG. 4 a further illustration of the message from FIG. 2.

FIG. 1 shows a telecommunication system SYS according to the invention with at least two PBX units TKA, TKB connected to each other by a telecommunication network NET, for example the PSTN network. These two PBX units TKA, TKB are integrated in a Centrex group. The two PBX units TKA, TKB each have a Centrex switching center VSA, VSB and public network ports A, B assigned to these switching centers.

One example of a Centrex switching center is the applicant's “EWSD” (Electronic digital dialing system), which essentially comprises a coordination processor, a plurality of (digital) subscriber line units (Line Units or Digital Line Units), port groups (LTG, line/trunk group) to connect subscriber lines and trunk lines, what is known as a switching network (SN) to switch lines through and a function unit to control the central signaling channel network (CCNC, common channel signaling network control). Another example of a Centrex switching center is the Alcatel system S12.

Different terminals, such as analog telephones, ISDN telephones and also complete PBX units or radio telephones, such as DECT cellular telephones, can be connected via the relevant interfaces. GSM cellular telephones can also be integrated into the Centrex call number schedule.

The Centrex functionality is achieved solely by means of software modules, so no hardware upgrades are required to existing switching centers VSA, VSB. Emulation by the software of a PBX in an ISDN switching center means that telephone services such as speed dialing, call pickup, automatic callback, call waiting, toggle, call diversion, conferencing, charges and call number display, which are standard and known for ISDN PBX units, are also available to Centrex group subscribers, without the subscribers actually requiring the physical presence of such a PBX.

As mentioned above, when a call is made from a Centrex port A of a first PBX TKA to a Centrex port B of a second PBX TKB, the actual call number of the first PBX TKA in the public telecommunication network NET and the Centrex group-internal, virtual call number VRA of the calling extension port A are transferred along with the actual, physical number PRA of the calling port A in the public telecommunication network NET. Transferring the physical call number of the extension port in the public telecommunication network means that MCI or LI can be carried out.

The forwarded call numbers are generally in the form of an entry in a message (Initial Address Message) IAM, which is signaled by the switching center VSA to the network. This message IAM, which is created using the caller side number in accordance with the standards (ETSI 300 092-1), contains a data field TE1 (Calling Party Number), into which the physical call number PRA of the calling extension A is input by the switching center VSA (FIG. 2). For this, the Centrex switching center VSA of the calling port A must know both the physical number PRA of the extension ports assigned to it and also the virtual, Centrex group-internal extension numbers VRA. Physical PRA numbers can be assigned to virtual VRA numbers in the Centrex call number schedule of this Centrex switching center VSA, for example.

The virtual extension number VRA can be input as an additional number (additional calling party number) in a field TE2 (generic number) of the message IAM, with the number RNA of the PBX TKA and the extension number of the calling port input as a further additional number (additional private group party).

The message IAM created in this way is signaled by the switching center VSA to the telecommunication network and transferred to the Centrex switching center VSB assigned to the called port B. If the called subscriber for example activates the MCI feature, this port can be identified from the physical call number PRA of the calling port A.

The invention allows simple call tracing in the sense of an MCI.

It should be pointed out here that the method according to the invention and the telephone system according to the invention can also be achieved by corresponding hardware solutions and the claims do not relate solely to a software solution. Nevertheless software solutions can be implemented at significantly lower cost and much more simply, so that these should generally be preferred.

To clarify the invention further, an example is shown with specific numbers signaled by the Centrex switching center VSA assigned to the calling port A.

In the example given here, it is assumed that the PBX TKA, i.e. the Centrex switching center VSA is assigned a physical number RNA=2501. The physical number of the local network of the PBX TKA is 0316. This means, for example, that a switching point in the PBX TKA can be reached at 0316 2501 together with the virtual number 10 of the calling extension A (0316 2501+10).

Also in the example given, the PBX TKA can also be reached at the virtual call number 05170 (known as the Centrex access code, which, for example with the applicant's above-mentioned EWSD, has a maximum of 5 figures), with the call number 05170 being converted to 0316 2501 in the public telecommunication network NET.

A physical number PRA is also assigned to every extension port in the PBX TKA, for example 4576 for extension port A, with the PBX-internal call number VRA of extension A being in the form of a virtual number, for example VRA=10. The number of the local network of extension A is 0316, so the corresponding extension A can be reached at the physical number PRA=0316 4576 or the virtual number 05170 10.

According to FIG. 3 and FIG. 4, when a call is made from extension A to extension B of the other Centrex switching center VSB, the Centrex switching center VSA signals the message IAM referred to above, known as an initial address message, to the public telecommunication network NET, with the physical number 0316 4576 (calling party number or CALLING_PARTY_NUMBER (LAC/DN¹)) in the first part TE1 of the message IAM and the virtual number 10 (generic number with number qualifier additional calling party number or GENERIC NUMBER with NQI_ADD_CALLING_PARTY_NUMBER (CXDN¹)) of the calling extension A in the second part TE2 and the physical number RNA of the PBX TKA 0316 2501 together with the virtual number 10 of the calling extension A (generic number with number qualifier additional private group party number or GENERIC_NUMBER with NQI_ADD_PRIVATE_GROUP_PARTY_NUMBER (DN_DAT¹+CXDN¹)) in a third part TE3 of the message IAM.

The physical call number PRA=0316 4576 of the calling extension A assigned to a first group CTX GR1 of ports or the first Centrex switching center VSA can be used by the Centrex switching center VSB of a second group of ports CTX GR2 assigned to the called extension B for an MCI if necessary. The above configuration of the message IAM allows a Calling Line Presentation or CLIP of the extension number of the calling port A at a terminal of the called port B and a lawful interception LI.

1. Method for identifying at least one port (A, B) assigned to a Centrex group in a telecommunication system (SYS) with at least two Centrex switching centers (VSA, VSB), connected to each other via a telecommunication network (NET), to each of which at least one Centrex group port (A, B) is assigned, with a physical call number (PRA, PRB) in the telecommunication network (NET) and a Centrex group-internal, virtual call number (VRA) assigned to each of the ports (A, B) and with at least the Centrex group-internal, virtual call number (VRA) of the calling port (A) being signaled by the first Centrex switching center (VSA) to the telecommunication network (NET) and being transferred by this to the second Centrex switching center (VSB), when a call is set up between a calling port (A) assigned to a first Centrex switching center (VSA) and a port (B) assigned to a second Centrex switching center (VSB),
characterized in that when a call is set up, the actual, physical call number (PRA) of the calling port (A) is also signaled by the Centrex switching center (VSA) to the telecommunication network (NET) along with the Centrex group-internal, virtual call number.

2. Method according to claim 1,
characterized in that when a call is set up between the calling port (A) and the called port (B) of the first Centrex switching center (VSA), an addressing message (IAM) is signaled to the telecommunication network (NET), the first part (TE1) of which contains the physical call number of the first port (A) and a further part (TE3) of which contains the virtual call number (VRA) of the first port and the physical call number of the first Centrex switching center (VSA).

3. Method according to claim 2,
characterized in that the addressing message (IAM) has a third part (TE3), which contains the virtual call number (VRA) of the calling port.

4. Telecommunication system (SYS) with at least two Centrex switching centers (VSA, VSB) connected to each other via a telecommunication network (NET), to each of which at least one Centrex group port (A, B) is assigned, with both a physical call number (PRA, PRB) and a Centrex group-internal, virtual call number (VRA) assigned to each of the ports (A, B), and each Centrex switching center (VSA, VSB) being set up to signal at least the Centrex group-internal, virtual call number (VRA) of the calling port (A) to the telecommunication network (NET), when a call is set up between a calling port (A) assigned to it and a second port (B) assigned to a different Centrex switching center (VSB), with the telecommunication network set up to transfer call numbers (VRA) signaled by the calling Centrex switching center (VSA, VSB) to the called Centrex switching center (VSB),
characterized in that the Centrex switching center (VSA), to which the calling port (A) is assigned, is set up to signal the actual, physical call number (PRA) of the calling port to the telecommunication network (NET) along with the Centrex group-internal, virtual call number, when a call is set up from the first port (A) to the second port (B).

5. Telecommunication system according to claim 4,
characterized in that the Centrex switching center (VSA), to which the calling port is assigned, is set up to signal an addressing message (IAM) to the telecommunication network (NET), when a call is set up between the calling port (A) and the called port (B), the first part (TE1) of said message containing the call number of the first port (A) and a further part (TE3) containing the physical call number of the first Centrex switching center (VSA) and the virtual, Centrex group-internal call number (CXDN1) of the calling port (A).

6. Telecommunication system according to claim 5,
characterized in that the addressing message (IAM) has a third part (TE3), which contains the PBX-internal, virtual call number (CXDN1) of the calling port.
